(19) United States
(12) Patent Application Publication
(10) Pub. No.: US 2022/0253713 A1
(43) Pub. Date: Aug. 11, 2022

(54) TRAINING NEURAL NETWORKS USING LAYER-WISE LOSSES

(71) Applicant: Google LLC, Mountain View, CA (US)

(72) Inventors: Ehsan Amid, Mountain View, CA (US); Manfred Klaus Warmuth, Santa Cruz, CA (US); Rohan Anil, San Francisco, CA (US)

(21) Appl. No.: 17/666,488

(22) Filed: Feb. 7, 2022

Related U.S. Application Data
(60) Provisional application No. 63/146,571, filed on Feb. 5, 2021.

(51) Int. Cl. G06N 3/08; G06N 3/04

(52) U.S. Cl. CPC G06N 3/084; G06N 3/0454

(57) ABSTRACT

Methods, systems, and apparatus, including computer programs encoded on computer storage media, for training a neural network using local layer-wise losses.

### CROSS-REFERENCE TO RELATED APPLICATION

This application claims priority to U.S. Provisional Application No. 63/146,571, filed on Feb. 5, 2021. The disclosure of the prior application is considered part of and is incorporated by reference in the disclosure of this application.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that trains a neural network that processes network inputs to generate network outputs. In particular, the system described in this specification trains the neural network using layer-wise losses, so that weight updates for the layers of the neural network can be computed in parallel for each of the layers in the neural network.

Particular embodiments of the subject matter described in this specification can be implemented so as to realize one or more of the following advantages.

This specification describes techniques for training a neural network using layer-wise updates, e.g., updates that are based on the matching losses of the transfer functions of the neural network layers. Training using this technique allows the system to take multiple gradient steps independently and in parallel for all, local, layer-wise problems. Training the neural network in this manner results in neural networks that outperform those trained using conventional backpropagation techniques and that are competitive with and, in some cases, outperform those trained using second order methods while consuming many fewer computational resources than these second order methods, i.e., because second order methods need to be carefully tuned for the task at hand, e.g., through computationally expensive hyper-parameter search. As the local problems are independent of each other, the inner updates can run in parallel, making it significantly faster than running multiple forward-backward steps. Compared to second order methods, the described techniques are significantly easier to implement and scale to larger networks, as second order methods typically rely on computing inverses and scale poorly when number of parameters is large.

Moreover, training using the described techniques allows a system to effectively parallelize the training and train the layers independently, in parallel. Because the devices assigned to each of the layers primarily focus on computing local, inner updates, the training can be easily distributed across multiple devices.

In other words, the described techniques leverage parallelism in order to improve the quality of network training relative to conventional backpropagation-based techniques with minimum additional computational overhead.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system.

FIG. 2 is a flow diagram of an example process for performing a training step during the training of the neural network.

FIG. 3 is a flow diagram of an example process for performing an update iteration to minimize a squared local loss based on the pre-activations.

FIG. 4 is a flow diagram of an example process for performing an update iteration to minimize a squared local loss based on the post-activations.

FIG. 5 is a flow diagram of an example process for performing an update iteration to minimize a local matching loss.

FIG. 6 is a flow diagram of an example process for performing an update iteration to minimize a dual Bregman divergence loss.

Like reference numbers and designations in the various drawings indicate like elements.

### DETAILED DESCRIPTION

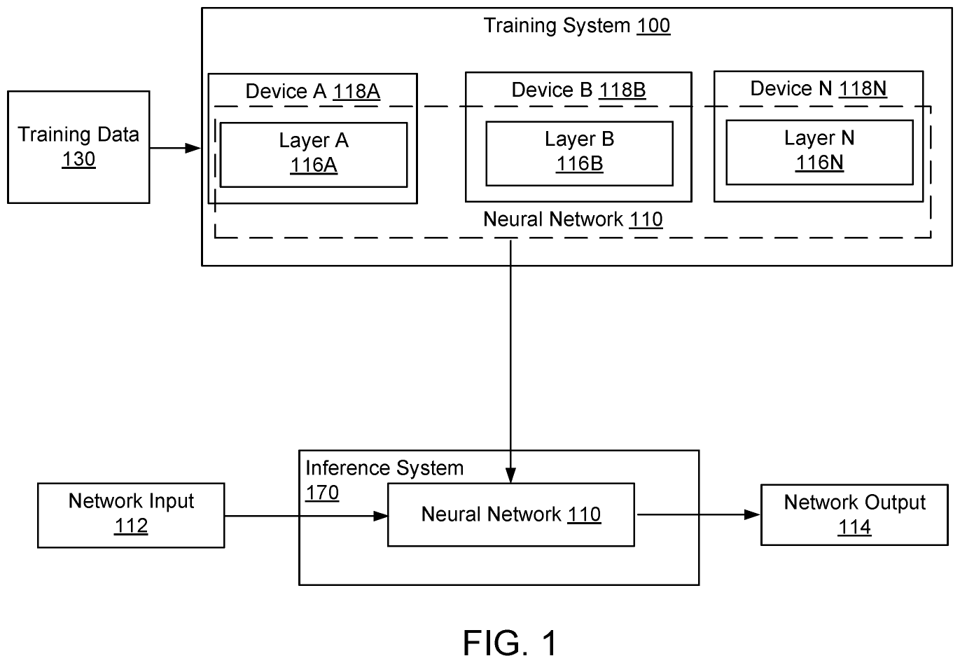

FIG. 1 shows an example training system 100. The training system 100 is an example of a system implemented as computer programs on one or more computers in one or more locations, in which the systems, components, and techniques described below can be implemented.

The system 100 trains a neural network 110 that is configured to perform a particular machine learning task on training data 130. That is, the neural network 110 is configured to process a network input 112 to generate a network output 114 for the network input 112 for the particular machine learning task.

The neural network 110 can be trained to perform any kind of machine learning task, i.e., can be configured to receive any kind of digital data input and to generate any kind of score, classification, or regression output based on the input.

In some cases, the neural network 110 is a neural network that is configured to perform an image processing task, i.e., receive an input image and to process the input image, i.e., process the intensity values of the pixels of the input image, to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the inputs to the neural network 110 are Internet resources (e.g., web pages), documents, or portions of documents or features extracted from Internet resources, documents, or portions of documents, the task can be to classify the resource or document, i.e., the output generated by the neural network 110 for a given Internet resource, document, or portion of a document may be a score for each of a set of topics, with each score representing an estimated likelihood that the Internet resource, document, or document portion is about the topic.

As another example, if the inputs to the neural network 110 are features of an impression context for a particular advertisement, the output generated by the neural network may be a score that represents an estimated likelihood that the particular advertisement will be clicked on.

As another example, if the inputs to the neural network 110 are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network 110 is a sequence of text in one language, the output generated by the neural network may be a score for each of a set of pieces of text in another language, with each score representing an estimated likelihood that the piece of text in the other language is a proper translation of the input text into the other language.

As another example, the task may be an audio processing task. For example, if the input to the neural network 110 is a sequence representing a spoken utterance, the output generated by the neural network may be a score for each of a set of pieces of text, each score representing an estimated likelihood that the piece of text is the correct transcript for the utterance. As another example, the task may be a keyword spotting task where, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

The training data 130 includes a set of training inputs and, for each training input, a label. The label for a given training input specifies the network output that should be generated by performing the machine learning task on the given training input, i.e., is a target output that should be generated by the neural network 110 after training.

The neural network 110 can have any appropriate architecture that allows the neural network 110 to perform the particular machine learning task, i.e., to map network inputs of the type and dimensions required by the task to network outputs of the type and dimensions required by the task. That is, when the task is a classification task, the neural network 110 maps the input to the classification task to a set of scores, one for each possible class for the task. When the task is a regression task, the neural network 110 maps the input to the regression task to a set of regressed values, one for each value that needs to be generated in order to perform the regression task.

As one example, when the inputs are images, the neural network 110 can be a convolutional neural network, e.g., a neural network having a ResNet architecture, an Inception architecture, an EfficientNet architecture, and so on, or a Transformer neural network, e.g., a vision Transformer.

As another example, when the inputs are text, features of medical records, audio data or other sequential data, the neural network 110 can be a recurrent neural network, e.g., a long short-term memory (LSTM) or gated recurrent unit (GRU) based neural network, or a Transformer neural network.

As another example, the neural network can be feed-forward neural network, e.g., an MLP, that includes multiple fully-connected layers.

Generally, however, the neural network 110 includes multiple layers 116A-116N that each have respective weights.

In particular, each of the multiple layers 116A-N is configured to receive a layer input and apply the respective weights for the layer to the layer input to generate a pre-activation for the layer. How the layer 116A-N applies the weights to the layer input depends on the type of neural network layer. For example, a convolutional layer computes a convolution between the weights and the layer input. As another example, a fully-connected layer computes a product between the weights of the layer and the layer input.

Each of the multiple layers 116A-N is then configured to apply a transfer function of the layer to the pre-activation to generate a post-activation, i.e., the layer output of the layer, and then provide the post-activation to one or more other layers of the neural network that are configured to receive input from the layer according to the neural network architecture. The transfer function of any given layer is an element-wise non-linear function, and different layers can have different transfer functions. Examples of transfer functions include ReLU, Leaky ReLU, Tanh, and Arc Tan. Another example of a transfer function is the identity function, i.e., for a linear layer that does not have an activation function.

The neural network 110 can have additional layers and components that do not have weights, e.g., normalization layers, pooling layers, residual connections, softmax layers, logistic layers, and so on.

Thus, to train the neural network 110, the training system 100 repeatedly updates the weights of the multiple layers 116-N using the training data 130 at different training steps to minimize a task loss function. The task loss function can be any appropriate differentiable loss function that is appropriate for the particular task, i.e., that measures the quality of an output generated by the neural network for a given input relative to the label for the given input for the particular task. Examples of task loss functions include cross-entropy losses, squared error losses, negative log likelihood losses, and so on. In some cases, the task loss function may also include one or more additional terms, e.g., auxiliary loss terms, regularization terms, and so on, that do not depend on the label for the given input.

In particular, at each training step, the system 100 performs a forward pass and a backward pass through the neural network to determine layer inputs and target pre- or post-activations for each layer.

The system 100 then performs, for each layer, a plurality of local update iterations to update the weights of the layer using the layer inputs and target pre- or post-activations. That is, unlike conventional first-order techniques, the system 100 performs multiple, local updating steps for each of the plurality of layers 106A-106N at each training step.

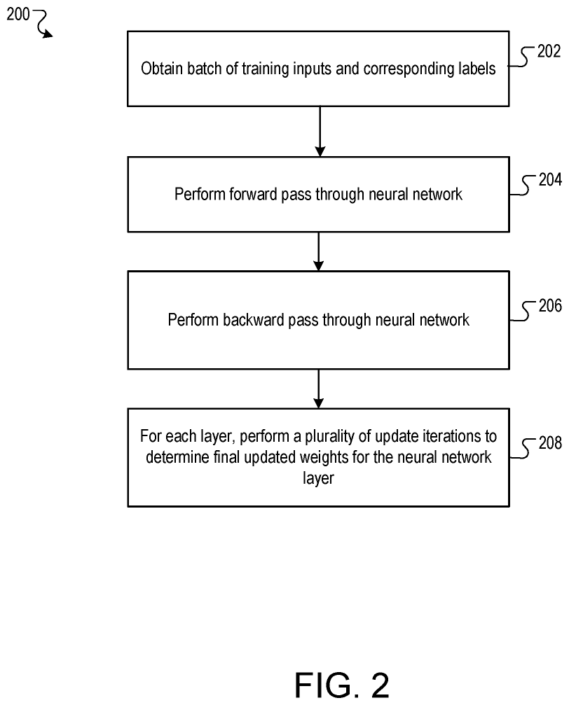

Performing a training step will be described in more detail below with reference to FIGS. 2-4.

In some implementations, the system 100 distributes the training of the neural network 100 across multiple devices.

In particular, the system 100 can distribute the training of the neural network 100 across multiple devices 118A-118N. Each device can be, e.g., a CPU, GPU, a TPU or other ASIC, an FPGA, or other computer hardware that is configured to perform the operations required to compute a layer output for at least one of the layers 116A-N and to compute gradients of the task loss function.

The system 100 can distribute the training of the neural network 100 in any of a variety of configuration. For example, as shown in FIG. 1, the system 100 can assign each of the layers 116A-116N to a different one of the devices 118A-118N. As another example, the system 100 can assign a different partition of the layers (that can include multiple layers) to each of the devices 118A-118N.

By distributing the training across devices, the system 100 can ensure that sufficient computational resources are available to perform the local updating steps in parallel for each of the layers 116A-116N at each training step. By performing the local updating steps in parallel, the system 100 realizes the advantages of the multiple update steps while minimizing the additional computational overhead required to perform multiple steps, i.e., instead of a single update step as is performed by conventional first-order optimizers.

After training, the training system 100 or a different inference system 170 deploys the trained student neural network 110 on one or more computing devices to perform inference, i.e., to generate new network outputs 114 for the machine learning task for new network inputs 112.

FIG. 2 is a flow diagram of an example process 200 for performing a training iteration during the training of the neural network. For convenience, the process 200 will be described as being performed by a system of one or more computers located in one or more locations. For example, a training system, e.g., the training system 100 of FIG. 1, appropriately programmed, can perform the process 200.

The system can repeatedly perform iterations of the process 200 to repeatedly update the network parameters until a termination criterion has been satisfied, e.g., until a threshold number of iterations of the process 200 have been performed, until a threshold amount of wall clock time has elapsed, or until the values of the network parameters have converged.

The system obtains a batch that includes one or more training inputs and a respective label for each training input (step 202). The system will generally obtain different training inputs at different iterations, e.g., by sampling a fixed number of inputs from a larger set of training data at each iteration. The label for each training input identifies a target output for the training input that should be generated by performing the particular machine learning task on the training input.

The system performs a forward pass through the neural network to generate a respective training network output for each training input in the batch (step 204). That is, the system processes each training network input through each layer in the neural network to generate a training output for the network input. As part of performing the forward pass, the system determines, for each training input in the batch and for each layer of the neural network, a respective layer input for the layer generated during the processing of the training input.

The system performs a backward pass through the neural network using, for each training input, the training output for the training input and the label for the training input to determine, for each layer of the neural network and for each training input, an estimated target for the neural network layer (step 206).

In some implementations, the estimated target is an estimated target pre-activation. For example, an estimated gradient descent (GD) target pre-activation aₘ for a given layer m can satisfy:

aₘ=äₘ−γ∇_{â}_{ₘ}L(y,ŷ),

where âₘ=Wₘŷₘ₋₁ is the current pre-activation for the layer, ŷₘ₋₁ is the layer input to the layer, Wₘ are the weights for the layer, and γ is a constant greater than zero that represents the activation learning rate, L(y,ŷ) is the task loss evaluated at the training output for the training input and the label for the training input, and ∇_{â}_{ₘ} denotes the gradient with respect to âₘ.

As another example, an estimated dual Mirror Descent (dual MD) target pre-activation aₘ for a given layer m can satisfy:

aₘ=âₘ−γ∇_{ŷ}_{ₘ}L(y,ŷ),

where âₘ=Wₘŷₘ₋₁ is the current pre-activation for the layer, ŷₘ₋₁ is the layer input to the layer, Wₘ are the weights for the layer, and γ is a constant greater than zero that represents the activation learning rate, L(y,ŷ) is the task loss evaluated at the training output for the training input and the label for the training input, and ∇_{ŷ}_{ₘ} denotes the gradient with respect to ŷₘ.

In some other implementations, the estimated target is an estimated target post-activation.

As one example, the estimated GD target post-activation yₘ for the given layer m can satisfy:

yₘ=ŷₘ−γ∇_{ŷ}_{ₘ}L(y,ŷ)),

where ŷₘ=fₘ(Wₘŷₘ₋₁) is the current post-activation for the layer and fₘ is the transfer function for the layer m, and ∇_{ŷ}_{ₘ}L(y,ŷ) is the gradient of L (y,ŷ) with respect to ŷₘ.

As another example, the estimated target Mirror Descent (MD) post-activation yₘ for the given layer m can satisfy:

yₘ=yₘ−γ∇_{â}_{ₘ}L(y,ŷ),

where ŷₘ=fₘ(Wₘŷₘ₋₁) and fₘ is the transfer function for the layer m.

In any of the above implementations, the system can compute the corresponding target by backpropagating gradients of the task loss through the neural network using conventional techniques to compute the required gradient and re-using the pre- or post-activations from the forward step or re-computing them during the backward step.

For each layer, the system then performs a plurality of update iterations to determine final updated weights for the layer using, for each training input and each layer, (i) the layer input generated for the training input for the layer and (ii) the estimated target for the training input for the layer (step 208).

For a given layer, at each update iteration, the system computes a gradient with respect to the weights of the layer of a local layer-wise loss and updates the current weights of the layer using the gradient. The local loss for any given layer includes (i) a local loss term that, for each training input, depends on the predicted pre-activation for the training input and the estimated target for the training input and (ii) a regularization term that penalizes deviations from the current weights of the neural network layer.

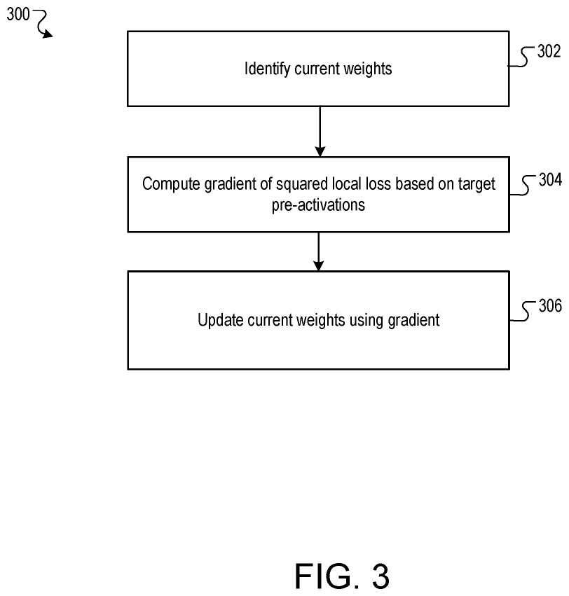

Examples of local losses are described below with reference to FIGS. 3-6.

The system then uses the updated weights after the last training iteration is performed as the final updated weights for the given layer, i.e., the weights that will be used to perform the next iteration of the process 200.

In particular, once the forward and backward passes are performed, the system can perform the plurality of update iterations independently and in parallel for each layer because the layer input and the estimated target are kept fixed and re-used at each update iteration, ensuring that no information from any other layers is necessary to perform the multiple update iterations.

For example, a respective device can be assigned to perform the updating for each of the layers and each device can perform the update iterations for the layer(s) assigned to the device in parallel with each other device.

In some implementations, each device includes a copy of each of the neural network layers and is assigned to perform the updating for a respective set of one or more of the layers.

In these implementations, each device can perform the forward and backward passes independently and then, after performing step 206, (i) provide, the final updated weights for access by the hardware devices performing the operations for the other neural network layers and (ii) obtain the final updated weights for the other neural network layers in the plurality of neural network layers for use in performing forward and backward passes through the neural network, i.e., at the next iteration of the process 200.

In some other implementations, each device includes a copy of only the layer(s) that are assigned to the device. In these implementations, to perform the forward pass, each device receives the layer inputs to the layer(s) assigned to the device, processes the layer input using the corresponding layer in accordance with the weights of the layer, and then provides the layer outputs to the devices to which the next layer(s) in the network architecture are assigned.

By performing multiple update iterations, i.e., instead of a single update iteration, the system can improve the quality of the training process relative to first-order training techniques. By ensuring that the update iterations are local to each layer and performing the update iterations in parallel for all of the layers, the system ensures that the additional training quality is achieved with minimal additional computational overhead relative to first-order training techniques.

FIG. 3 is a flow diagram of an example process 300 for performing an update iteration to minimize a squared local loss based on pre-activations for a given layer. For convenience, the process 300 will be described as being performed by a system of one or more computers located in one or more locations. For example, a training system, e.g., the training system 100 of FIG. 1, appropriately programmed, can perform the process 300.

The system can perform a fixed number T of update iterations for the given layer at each iteration of the training process, i.e., at each iteration of the process 200.

Prior to performing any iterations of the process 300, the system obtains, for each training input, a layer input for the training input and an estimated GD target pre-activation for the training input, i.e., as a result of performing the forward and backward pass described above with reference to FIG. 2.

The system identifies the current weights of the layer (step 302). For the first update iteration, the current weights are the weights as of the end of the previous iteration of the process 200. For each subsequent iteration, the current weights are the weights as of the end of the previous update iteration, i.e., the updated weights after the previous iteration of the process 300.

The system computes a gradient with respect to the weights of the given neural network layer of the squared local loss in accordance with current weights of the particular neural network layer using the layer inputs for the training inputs in the batch and the estimated GD target pre-activations for the training inputs in the batch (step 304).

In particular, the squared local loss includes two terms: (i) the squared loss between pre-activations generated in accordance with updated weights and the GD target pre-activations and (ii) a regularization term that penalizes the layer for differences between the current weights and updated weights. For example, the squared local loss for a layer m can satisfy:

$${argmin}_{\tilde{W}} \{ 1 / 2 {‖ \tilde{W} {\hat{y}}_{m - 1} - {a}_{m} ‖}^{2} + 1 / 2 η {‖ \tilde{W} - {W}_{m} ‖}^{2} \} ,$$

where \tilde{W} are the updated weights of the layer, ŷₘ₋₁ is the layer input to the layer, aₘ is the GD target pre-activation for the layer input, Wₘ are the current weights for the layer, and η is a constant greater than zero that controls the trade-off between minimizing the loss and the regularization.

To compute the gradient of this loss at a given update iteration, the system computes new pre-activations by applying the current weights to the layer input and computes the difference between the new pre-activations and the estimated GD target pre-activations. The system then computes the gradient based on this difference. In particular, the gradient is equal to: η(Wₘ ŷₘ₋₁−aₘ)ŷ^{T}ₘ₋₁.

Thus, the system keeps the layer input for the training input and the estimated target pre-activation for the training input fixed across all of the update iterations, ensuring that performing the update iterations does not require any additional backward and forward passes through the neural network and that, therefore, the update iterations can be performed independently and in parallel for each layer.

The system updates the current weights of the particular neural network layer using the gradient (step 306). For example, the system can subtract the gradient from the current weights to generate the updated weights.

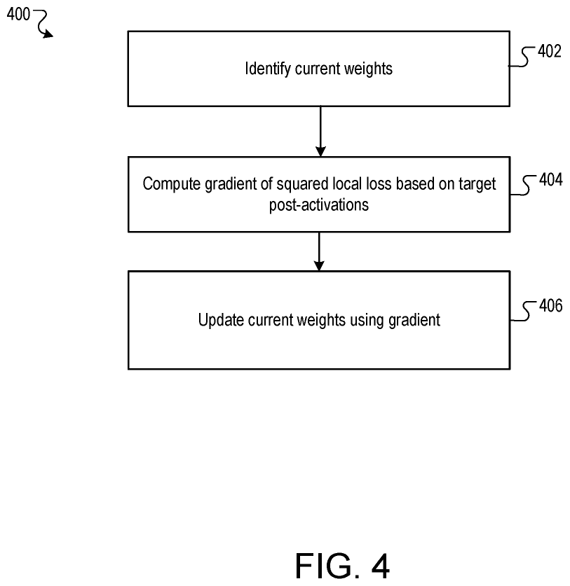

FIG. 4 is a flow diagram of an example process 400 for performing an update iteration to minimize a squared local loss based on post-activations for a given layer. For convenience, the process 400 will be described as being performed by a system of one or more computers located in one or more locations. For example, a training system, e.g., the training system 100 of FIG. 1, appropriately programmed, can perform the 400.

The system can perform a fixed number T of update iterations for the given layer at each iteration of the training process, i.e., at each iteration of the process 200.

Prior to performing any iterations of the process 400, the system obtains, for each training input, a layer input for the training input and an estimated GD target post-activation for the training input, i.e., as a result of performing the forward and backward pass described above with reference to FIG. 2.

The system identifies the current weights of the layer (step 402). For the first update iteration, the current weights are the weights as of the end of the previous iteration of the process 200. For each subsequent iteration, the current weights are the weights as of the end of the previous update iteration, i.e., the updated weights after the previous iteration of the process 400.

The system computes a gradient with respect to the weights of the given neural network layer of the squared local loss in accordance with current weights of the particular neural network layer using the layer inputs for the training inputs in the batch and the estimated GD target post-activations for the training inputs in the batch (step 404).

In particular, the squared local loss includes two terms: (i) the squared loss between post-activations generated in accordance with updated weights and the GD target post-activations and (ii) a regularization term that penalizes the layer for differences between the current weights and updated weights. For example, the squared local loss for a layer m can satisfy:

$${argmin}_{\tilde{W}} \{ 1 / 2 {‖ {f}_{m} ( \tilde{W} {\hat{y}}_{m - 1} ) - {y}_{m} ‖}^{2} + 1 / 2 η {‖ \tilde{W} - {W}_{m} ‖}^{2} \} ,$$

where yₘ is the GD target post-activation for the layer input, Wₘ are the current weights for the layer, and η is a constant greater than zero that controls the trade-off between minimizing the loss and the regularization terms.

To compute the gradient of this loss at a given update iteration, the system computes new pre-activations by applying the current weights to the layer input and computes new post-activations by applying the transfer function to the new pre-activations and then computes the difference between the new post-activations and the estimated GD target post-activations. The system then computes the gradient based on this difference. In particular, the gradient is equal to:

ηJ_{f}_{ₘ}^{T}(fₘ(Wₘŷₘ₋₁)−yₘ)ŷ^{T}ₘ₋₁,

where J_{f}_{ₘ}^{T} is the transpose of the Jacobian of the transfer function fₘ.

Thus, the system keeps the layer input for the training input and the estimated target post-activation for the training input fixed across all of the update iterations, ensuring that performing the update iterations does not require any additional backward and forward passes through the neural network and that, therefore, the update iterations can be performed independently and in parallel for each layer.

The system updates the current weights of the particular neural network layer using the gradient (step 406). For example, the system can subtract the gradient from the current weights to generate the updated weights.

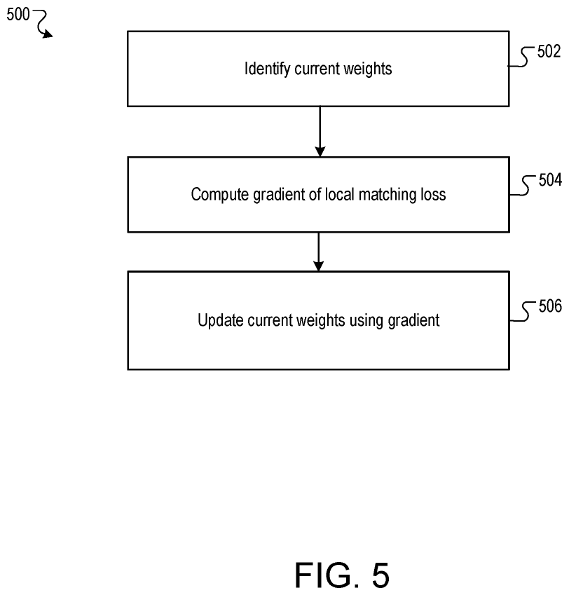

FIG. 5 is a flow diagram of an example process 500 for performing an update iteration to minimize a local matching loss for a given layer. For convenience, the process 500 will be described as being performed by a system of one or more computers located in one or more locations. For example, a training system, e.g., the training system 100 of FIG. 1, appropriately programmed, can perform the process 500.

The system can perform a fixed number T of update iterations for the given layer at each iteration of the training process, i.e., at each iteration of the process 200.

Prior to performing any iterations of the process 500, the system obtains, for each training input, a layer input for the training input and an estimated MD target post-activation for the training input, i.e., as a result of performing the forward and backward pass described above with reference to FIG. 2.

The system identifies the current weights of the layer (step 502). For the first update iteration, the current weights are the weights as of the end of the previous iteration of the process 200. For each subsequent iteration, the current weights are the weights as of the end of the previous update iteration, i.e., the updated weights after the previous iteration of the process 500.

The system computes a gradient with respect to the weights of the given neural network layer of the local matching loss of the transfer function for the layer in accordance with current weights of the layer using the layer inputs for the training inputs in the batch and the estimated MD target post-activations for the training inputs in the batch (step 504).

The matching loss of a transfer function ƒ is a measure of discrepancy between a target output of the transfer function and the actual output of the transfer function. In particular, the matching loss L_{ƒ} of a transfer function ƒ is defined as the following line integral of ƒ:

∫ₐ^{â}(f(z)−f(a))^{T}dz,

where a is the target pre-activation.

Matching losses of various common transfer functions are shown below in Table 1.

TABLE 1

| NAME | TRANSFER FUNCTION ƒ(a) | CONVEX INTEGRAL FUNCTION F(a) | NOTE |
|---|---|---|---|
| STEP FUNCTION | ½ (1 + sign(a)) | Σᵢ max(aᵢ, 0) | — |
| LINEAR | a | ½ ∥a∥² | — |
| (LEAKY) RELU | max(a, 0) − βmax(−a, 0) | ½ Σᵢ aᵢ(max(aᵢ, 0) − β max(−aᵢ, 0)) | β ≥ 0 |
| SIGMOID | (1 + exp(−a))⁻¹ | Σᵢ (aᵢ + log(1 + exp(−aᵢ))) | — |
| SOFTMAX | exp(a)/Σᵢ^{exp(a}^{ᵢ}⁾ | log Σᵢ exp(aᵢ) | — |
| HYPERBOLIC TAN | tanh(a) | Σᵢ log cosh(aᵢ) | — |
| ARC TAN | arctan(a) | ${\sum }_{i} ( {a}_{i} arc tan ( {a}_{i} ) - log \sqrt{1 + {a}_{i}^{2}} )$ | — |
| SOFTPLUS | log(1 + exp(a)) | −ΣᵢLi₂(−exp(aᵢ)) | Li₂ := SPENCE'S FUNC. |
| ELU | ${[ f ( a ) ]}_{i} = \{ \begin{matrix}{a}_{i} & {a}_{i} \geq 0 \\ β ( exp {a}_{i} - 1 ) & OTHERWISE\end{matrix}$ | ${\sum }_{i} ( {a}_{i}^{2} / 2 𝕀 ( {a}_{i} \geq 0 ) + β ( exp {a}_{i} - {a}_{i} - 1 ) ) 𝕀 ( {a}_{i} < 0 ) )$ | β ≥ 0 |

In particular, the local matching loss includes two terms: (i) the matching loss between post-activations generated in accordance with updated weights and the target MD post-activations and (ii) a regularization term that penalizes the layer for differences between the current weights and updated weights. For example, the local matching loss for a layer m can satisfy:

$${argmin}_{\tilde{W}} \{ {L}_{{f}_{m}} ( {y}_{m} , {f}_{m} ( \tilde{W} {\hat{y}}_{m - 1} ) ) + 1 / 2 η {‖ \tilde{W} - {W}_{m} ‖}^{2} \} ,$$

where \tilde{W} are the updated weights of the layer, ŷₘ₋₁ is the layer input to the layer, yₘ is the MD target post-activation for the layer input, Wₘ are the current weights for the layer, L_{f}_{ₘ} is the matching loss for the transfer function fₘ of the layer, and η is a constant greater than zero that controls the trade-off between minimizing the loss and the regularization.

To compute the gradient of this loss at a given update iteration, the system computes new pre-activations by applying the current weights to the layer input, computes new post-activations by applying the transfer function to the new pre-activations and computes the difference between the new post-activations and the estimated MD target post-activations. The system then computes the gradient based on this difference. In particular, the gradient is equal to: η(fₘ(Wₘŷₘ₋₁₁)−yₘ)ŷₘ₋₁^{T}.

Thus, the system keeps the layer input for the training input and the estimated target post-activation for the training input fixed across all of the update iterations, ensuring that performing the update iterations does not require any additional backward and forward passes through the neural network and that, therefore, the update iterations can be performed independently and in parallel for each layer. Additionally, although different transfer functions may have different matching losses, calculating the gradient requires only the value of the layer input and the difference between the post and MD target post-activations, allowing the process 500 to be used for layers with a variety of different transfer functions.

The system updates the current weights of the particular neural network layer using the gradient (step 506). For example, the system can subtract the gradient from the current weights to generate the updated weights.

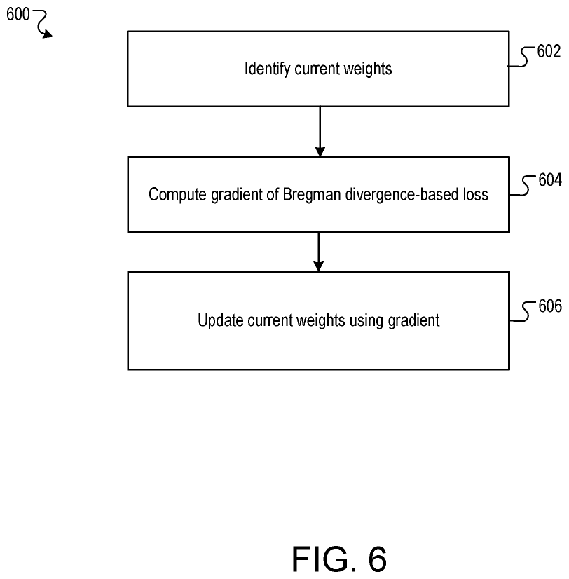

FIG. 6 is a flow diagram of an example process 600 for performing an update iteration to minimize a Bregman divergence-based loss for a given layer. For convenience, the process 600 will be described as being performed by a system of one or more computers located in one or more locations. For example, a training system, e.g., the training system 100 of FIG. 1, appropriately programmed, can perform the process 600.

The system can perform a fixed number T of update iterations for the given layer at each iteration of the training process, i.e., at each iteration of the process 200.

Prior to performing any iterations of the process 600, the system obtains, for each training input, a layer input for the training input and an estimated dual MD target pre-activation for the training input, i.e., as a result of performing the forward and backward pass described above with reference to FIG. 2.

The system identifies the current weights of the layer (step 602). For the first update iteration, the current weights are the weights as of the end of the previous iteration of the process 200. For each subsequent iteration, the current weights are the weights as of the end of the previous update iteration, i.e., the updated weights after the previous iteration of the process 600.

The system computes a gradient with respect to the weights of the given neural network layer of the local matching loss of the transfer function for the layer in accordance with current weights of the layer using the layer inputs for the training inputs in the batch and the estimated dual MD target pre-activations for the training inputs in the batch (step 604).

In particular, the loss includes two terms: (i) the loss between the dual of the Bregman divergence between post-activations generated in accordance with updated weights and post-activations generated from the dual MD target pre-activations and (ii) a regularization term that penalizes the layer for differences between the current weights and updated weights. For example, the loss for a layer m can satisfy:

$${argmin}_{\tilde{W}} \{ {D}_{F {*}_{m}} ( {f}_{m} ( \tilde{W} {\hat{y}}_{m - 1} ) , {f}_{m} ( {a}_{m} ) ) + 1 / 2 η {‖ \tilde{W} - {W}_{m} ‖}^{2} \} ,$$

where D_{F*}_{ₘ} is the dual of the Bregman divergence, and aₘ is the dual MD target pre-activation for the layer input.

To compute the gradient of this loss at a given update iteration, the system computes new pre-activations by applying the current weights to the layer input and computes the difference between the new post-activations and the estimated dual MD target pre-activations. The system then computes the gradient based on this difference. In particular, the gradient is equal to:

ηJ_{f}_{ₘ}^{T}(Wₘŷₘ₋₁−aₘ)ŷ^{T}ₘ₋₁,

where J_{f}_{ₘ}^{T} is the transpose of the Jacobian of the transfer function fₘ and aₘ is the dual MD target pre-activation for the layer input.

Thus, the system keeps the layer input for the training input and the estimated target pre-activation for the training input fixed across all of the update iterations, ensuring that performing the update iterations does not require any additional backward and forward passes through the neural network and that, therefore, the update iterations can be performed independently and in parallel for each layer.

The system updates the current weights of the particular neural network layer using the gradient (step 606). For example, the system can subtract the gradient from the current weights to generate the updated weights.

The description of FIGS. 3-6 describes computing gradients of a single training input. When the batch includes multiple training inputs, the system can combine, e.g., average or sum, these gradients at each update iteration and then use the combined gradient to update the weights at the update iteration, i.e., use the combined gradient in steps 306, 406, 506, or 606 to update the current weights at the update iteration.

Additionally, the description above describes that a pre-activation is generated by computing a product between the layer input and a weight matrix of the weights (i.e., Wₘŷₘ₋₁). More generally, however, the pre-activation can be generated by computing any linear transformation that depends on the current weights of the layer and the layer input to the layer. As another example, i.e., in addition to matrix-vector multiplication, the linear transformation can be a convolution between a kernel of the weights and the layer input, i.e., for a convolutional layer.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for training a neural network having a plurality of neural network layers each having a respective set of weights, the method comprising repeatedly performing, for each particular neural network layer of the plurality of neural network layers, operations comprising:
obtaining a batch comprising one or more training inputs and a respective label for each training input;
for each training input in the batch;
performing a forward pass through the neural network on the training input to determine at least a layer input to the particular neural network layer and a training output for the training input, and
performing a backward pass through the neural network using the training output for the training input and the label for the training input to determine an estimated target for the particular neural network layer, wherein the estimated target is a target pre-activation or a target post-activation for the neural network layer; and
performing a plurality of update iterations to determine final updated weights for the particular neural network layer, wherein performing each update iteration comprises:
identifying current weights of the particular neural network layer as of the update iteration;
for each training input, applying the current weights to the layer input for the training input to generate a predicted pre-activation for the training input; and
computing a gradient with respect to the weights of the particular neural network layer of a respective local loss for the particular layer that includes (i) a local loss term that, for each training input, depends on the predicted pre-activation for the training input and the estimated target for the training input and (ii) a regularization term that penalizes deviations from the current weights of the particular neural network layer; and
updating the current weights of the particular neural network layer using the gradient.

2. The method of claim 1, wherein the update iterations are performed in parallel for each of the plurality of neural network layers.

3. The method of claim 2, wherein the operations for each of the neural network layers are assigned to and performed on a respective hardware device.

4. The method of claim 3, wherein the operations further comprise:
for each neural network layer, providing, by the respective hardware device for the neural network layer, the final updated weights for access by the hardware devices performing the operations for the other neural network layers and obtaining, by the respective hardware device for the neural network layer, the final updated weights for the other neural network layers in the plurality of neural network layers for use in performing forward and backward passes through the neural network.

5. The method of claim 1, wherein the batch includes the same training inputs for all of the plurality of layers.

6. The method of claim 1, wherein the layer inputs and the estimated targets for the particular neural network layer are fixed for each of the plurality of update iterations.

7. The method of claim 1, wherein determining estimated targets for the particular neural network layer comprises backpropagating gradients of a final loss between the training output for the training input and the label for the training input.

8. The method of claim 1, wherein the estimated targets for the particular neural network layer are mirror descent (MD) target post-activations.

9. The method of claim 8, wherein computing a gradient with respect to the weights of the layer of a respective local loss comprises, for each training input in the batch:
applying a transfer function for the particular neural network layer to the predicted pre-activation for the training input to generate a predicted post-activation; and
determining a difference between the predicted post-activations and the estimated target post-activations for the training input.

10. The method of claim 9, wherein determining the gradient further comprises, for each training input in the batch:
computing a product of the layer input for the training input and the difference determined for the layer input.

11. A system comprising one or more computers and one or more storage devices storing instructions that are operable, when executed by the one or more computers, to cause the one or more computers to perform operations for training a neural network having a plurality of neural network layers each having a respective set of weights, the operations comprising repeatedly performing, for each particular neural network layer of the plurality of neural network layers, training operations comprising:
obtaining a batch comprising one or more training inputs and a respective label for each training input;
for each training input in the batch;
performing a forward pass through the neural network on the training input to determine at least a layer input to the particular neural network layer and a training output for the training input, and
performing a backward pass through the neural network using the training output for the training input and the label for the training input to determine an estimated target for the particular neural network layer, wherein the estimated target is a target pre-activation or a target post-activation for the neural network layer; and
performing a plurality of update iterations to determine final updated weights for the particular neural network layer, wherein performing each update iteration comprises:
identifying current weights of the particular neural network layer as of the update iteration;
for each training input, applying the current weights to the layer input for the training input to generate a predicted pre-activation for the training input; and
computing a gradient with respect to the weights of the particular neural network layer of a respective local loss for the particular layer that includes (i) a local loss term that, for each training input, depends on the predicted pre-activation for the training input and the estimated target for the training input and (ii) a regularization term that penalizes deviations from the current weights of the particular neural network layer; and
updating the current weights of the particular neural network layer using the gradient.

12. The system of claim 11, wherein the update iterations are performed in parallel for each of the plurality of neural network layers.

13. The system of claim 12, wherein the update iterations for each of the neural network layers are assigned to and performed on a respective hardware device.

14. The system of claim 13, wherein the training operations further comprise:
for each neural network layer, providing, by the respective hardware device for the neural network layer, the final updated weights for access by the hardware devices performing the operations for the other neural network layers and obtaining, by the respective hardware device for the neural network layer, the final updated weights for the other neural network layers in the plurality of neural network layers for use in performing forward and backward passes through the neural network.

15. The system of claim 11, wherein the layer inputs and the estimated targets for the particular neural network layer are fixed for each of the plurality of update iterations.

16. The system of claim 11, wherein determining estimated targets for the particular neural network layer comprises backpropagating gradients of a final loss between the training output for the training input and the label for the training input.

17. The system of claim 11, wherein the estimated targets for the particular neural network layer are mirror descent (MD) target post-activations.

18. The system of claim 17, wherein computing a gradient with respect to the weights of the layer of a respective local loss comprises, for each training input in the batch:
applying a transfer function for the particular neural network layer to the predicted pre-activation for the training input to generate a predicted post-activation; and
determining a difference between the predicted post-activations and the estimated target post-activations for the training input.

19. The system of claim 18, wherein determining the gradient further comprises, for each training input in the batch:
computing a product of the layer input for the training input and the difference determined for the layer input.

20. One or more non-transitory computer-readable storage media encoded with instructions that, when executed by one or more computers, cause the one or more computers to perform operations for training a neural network having a plurality of neural network layers each having a respective set of weights, the method comprising repeatedly performing, for each particular neural network layer of the plurality of neural network layers, operations comprising:
obtaining a batch comprising one or more training inputs and a respective label for each training input;
for each training input in the batch;
performing a forward pass through the neural network on the training input to determine at least a layer input to the particular neural network layer and a training output for the training input, and
performing a backward pass through the neural network using the training output for the training input and the label for the training input to determine an estimated target for the particular neural network layer, wherein the estimated target is a target pre-activation or a target post-activation for the neural network layer; and
performing a plurality of update iterations to determine final updated weights for the particular neural network layer, wherein performing each update iteration comprises:
identifying current weights of the particular neural network layer as of the update iteration;
for each training input, applying the current weights to the layer input for the training input to generate a predicted pre-activation for the training input; and
computing a gradient with respect to the weights of the particular neural network layer of a respective local loss for the particular layer that includes (i) a local loss term that, for each training input, depends on the predicted pre-activation for the training input and the estimated target for the training input and (ii) a regularization term that penalizes deviations from the current weights of the particular neural network layer; and
updating the current weights of the particular neural network layer using the gradient.
